(19) United States
(12) Patent Application Publication
(10) Pub. No.: US 2026/0329097 A1
(43) Pub. Date: Oct. 22, 2026

(54) IMAGE DISPLAY DEVICE AND LIGHT GUIDE PLATE

(71) Applicant: SONY GROUP CORPORATION, Tokyo (JP)

(72) Inventor: Daisuke UEDA, Tokyo (JP)

(73) Assignee: SONY GROUP CORPORATION, Tokyo (JP)

(21) Appl. No.: 19/109,765

(22) PCT Filed: Aug. 18, 2023
(86) PCT No.: PCT/JP2023/029786

§ 371 Date: Mar. 7, 2025

(30) Foreign Application Priority Data
Sep. 21, 2022 (JP) 2022-149904

(51) Int. Cl. G02B 27/01; G02B 27/00

(52) U.S. Cl. CPC G02B 27/0179; G02B 27/0093; G02B 27/0172; G02B 2027/0187

(57) ABSTRACT

The present technology provides a system comprising an eye tracking device that generates eyeball information of an eyeball of a user. The system comprises an image output device that outputs light to the eyeball of the user, and an image generator that generates and actively adjusts light traveling along an optical path to the image output device based on the eyeball information.

### CROSS REFERENCE TO RELATED APPLICATIONS

This application claims the benefit of Japanese Priority Patent Application JP 2022-149904 filed on Sep. 21, 2022, the entire contents of which are incorporated herein by reference.

### TECHNICAL FIELD

The present technology relates to an image display device and a light guide plate.

### BACKGROUND ART

In related art, to realize extended reality (XR) including augmented reality (AR), virtual reality (VR), mixed reality (MR), and the like, technology of projecting image light on an eyeball of a user to cause the user to visually recognize an image has been developed. For example, Patent Literatures 1 and 2 disclose techniques of projecting image light on an eyeball of a user to cause the user to visually recognize an image.

### CITATION LIST

### Patent Literature

PTL 1: WO 2021/220638 A
PTL 2: JP H6-308422 A

### SUMMARY

### Technical Problem

There is room for improvement in downsizing of the display devices described in Patent Literatures 1 and 2.

Therefore, it is desirable to provide an image display device and a light guide plate that contribute to downsizing of the device.

### Solution to Problem

The present technology provides an image display device including an image light generation unit that generates an image light, a light guide plate that guides the image light to an eyeball of a user, and a detection unit that detects eyeball information that is information associated with the eyeball. The image light generation unit is configured to be capable of switching a plurality of the image lights to be emitted to the light guide plate on the basis of the eyeball information, and the light guide plate includes at least a substrate that totally reflects and guides the image light incident, and a deflection part that condenses the image light to a rotation center of the eyeball.

The eyeball information may include line-of-sight information.

The eyeball information may include a pupil diameter of the eyeball.

The eyeball information may further include an eye relief that is a distance from the deflection part to a corneal vertex of the eyeball, or a distance from the corneal vertex of the eyeball to a rotation center of the eyeball, or both.

When the deflection part is formed on the eyeball side of the substrate, the following Expression (6) may be satisfied, where φ is an incident angle of the image light on the light guide plate, L is an eye relief that is a distance from the deflection part to a corneal vertex of the eyeball, r is a distance from the corneal vertex of the eyeball to a rotation center of the eyeball, Φ is a pupil diameter of the eyeball, and t is a thickness of the substrate.

t>(L+r)*Φ/(2*r*tan φ) (6)

When the deflection part is formed on a side opposite to the eyeball side of the substrate, the following Expression (15) may be satisfied, where φ is an incident angle of the image light on the light guide plate, L is an eye relief that is a distance from the deflection part to a corneal vertex of the eyeball, r is a distance from the corneal vertex of the eyeball to a rotation center of the eyeball, Φ is a pupil diameter of the eyeball, t is a thickness of the substrate, and θ1 is an angle of view of the image light in the substrate.

t>(L+r)*Φ/(2*r*(tan φ−tan θ1)) (15)

The deflection part may be a diffractive optical element that diffracts the image light to the rotation center of the eyeball.

The deflection part may be a holographic grating.

The deflection part may be a surface relief grating.

The deflection part may be a reflection optical element that reflects the image light to the rotation center of the eyeball.

The image display device may further include a light shielding part that shields part of the image light emitted by the image light generation unit.

The light shielding part may have a spatial distribution in a light shielding degree of the image light.

The light shielding part may be configured to be able to shield the image light and cancel the shielding of the image light in time series.

The light shielding part may be a mask with a light shielding position that is variable.

The light shielding part may be a liquid crystal element.

The image display device may further include a drive unit that moves the light guide plate in an eye relief direction that is a distance direction from the deflection part to a corneal vertex of the eyeball.

The image display device may further include a calibration unit that acquires a deviation from a reference position of the user on the basis of a user operation on a calibration image including the image light.

The image display device may further include a sensor unit that acquires an eye relief that is a distance from the deflection part to a corneal vertex of the eyeball, or a distance from the corneal vertex of the eyeball to a rotation center of the eyeball, or both.

Further, the present technology provides a light guide plate including a substrate that totally reflects and guides the incident image light, a deflection part that condenses the image light at a rotation center of an eyeball, and a detection unit that detects eyeball information that is information associated with an eyeball, in which the deflection part condenses the image light switched on the basis of the eyeball information at the rotation center of the eyeball.

When the deflection part is formed on the eyeball side of the substrate, the following Expression (6) may be satisfied, where φ is an incident angle of the image light on the light guide plate, L is an eye relief that is a distance from the deflection part to a corneal vertex of the eyeball, r is a distance from the corneal vertex of the eyeball to a rotation center of the eyeball, Φ is a pupil diameter of the eyeball, and t is a thickness of the substrate.

t>(L+r)*Φ/(2*r*tan φ) (6)

When the deflection part is formed on a side opposite to the eyeball side of the substrate, the following Expression (15) may be satisfied, where φ is an incident angle of the image light on the light guide plate, L is an eye relief that is a distance from the deflection part to a corneal vertex of the eyeball, r is a distance from the corneal vertex of the eyeball to a rotation center of the eyeball, Φ is a pupil diameter of the eyeball, t is a thickness of the substrate, and θ1 is an angle of view of the image light in the substrate.

t>(L+r)*Φ/(2*r*(tan φ−tan θ1)) (15)

The present technology provides a system comprising an eye tracking device that generates eyeball information of an eyeball of a user of the system. The system comprises an image output device that outputs light to the eyeball of the user, and an image generator that generates and actively adjusts light traveling along an optical path to the image output device based on the eyeball information.

The image output device outputs light to a predetermined area of the eyeball. The light output to the predetermined area of the eyeball condenses at or near a rotation center of the eyeball. The image output device comprises a light guide and an optical component that directs light traveling in the light guide to the eyeball of the user. The image generator comprises a movable mirror that actively adjusts a direction of the light traveling along the optical path to the image output device. The system comprises a light shield that actively adjusts an amount of the light traveling along the optical path to the image output device. The system further comprises a collimating lens positioned between the image generator and the image output device. The eyeball information includes line-of-sight information, pupil information, and eye relief information. The pupil information comprises a diameter of a pupil of the eyeball. The image output device is movable in a direction toward the eyeball of the user. The system comprises a calibration device that determines the user's deviation from a reference position. The system comprises a sensor for sensing a distance between the image output device and a corneal vertex of the eyeball. The light generated by the image generator comprises laser light.

The present technology includes a system comprises an image generator, and the image generator includes a light source that generates light, a controllable device that adjusts light output from the light source, and a controller that controls the controllable device based on output of an eye tracking device that generates eyeball information of an eyeball of a user of the system. The light output to the predetermined area of the eyeball condenses at or near a rotation center of the eyeball.

The system further comprises an image output device that outputs light received from the image generator to the eyeball of the user. The system further comprises a collimating lens positioned between the image generator and the image output device. The controllable device comprises a controllable light shield positioned between the collimating lens and the image output device. The controllable device comprises a movable mirror positioned between the light source and the collimating lens.

The present technology provides a method for a display system comprises receiving eyeball information about an eyeball of a user of the display system, generating light for displaying images to the eyeball of the user through an image output device, and actively adjusting the light traveling along an optical path to the image output device based on the eyeball information such that light output from the image output device condenses at a center of rotation of the eyeball.

Actively adjusting the light includes controlling an optical element to redirect the light or to selectively block portions of the light.

According to the present technology, it is possible to provide an image display device and a light guide plate that contribute to downsizing of the device. Note that the effects described herein are not necessarily limited, and effects may be any of the effects described in the present disclosure.

### BRIEF DESCRIPTION OF DRAWINGS

FIG. 1 is a schematic diagram illustrating a configuration example of an image display device according to a first embodiment of the present technology.

FIG. 2 is a block diagram illustrating a configuration example of the image display device according to the first embodiment of the present technology.

FIG. 3 is a flowchart illustrating an example of processing of an image light generation unit according to the first embodiment of the present technology.

FIG. 4 is a schematic diagram illustrating a correlation between a light guide plate and an eyeball according to the first embodiment of the present technology.

FIG. 5 is a schematic diagram illustrating a correlation between the light guide plate and the eyeball according to the first embodiment of the present technology.

FIG. 6 is a schematic diagram illustrating a configuration example of an image display device according to a second embodiment of the present technology.

FIG. 7 is a block diagram illustrating a configuration example of the image display device according to the second embodiment of the present technology.

FIG. 8 is a flowchart illustrating an example of processing of the image light generation unit according to the second embodiment of the present technology.

FIG. 9 is a schematic diagram illustrating a configuration example of an image display device according to a third embodiment of the present technology.

FIG. 10 is a block diagram illustrating a configuration example of the image display device according to the third embodiment of the present technology.

FIG. 11 is a block diagram illustrating a configuration example of an image display device according to a fourth embodiment of the present technology.

FIG. 12 is a block diagram illustrating a configuration example of an image display device according to a fifth embodiment of the present technology.

### DESCRIPTION OF EMBODIMENTS

Hereinafter, preferred embodiments for carrying out the present technology will be described with reference to the drawings. Note that the embodiment described below illustrates an example of a representative embodiment of the present technology, and the scope of the present technology is not limited by this. Further, the present technology can combine any of the following examples and modifications thereof.

In the following description of the embodiment, the configuration may be described using terms with “substantially” such as substantially parallel and substantially orthogonal. For example, substantially parallel means not only being completely parallel, but also being substantially parallel, that is, including a state shifted by, for example, about several percent from a completely parallel state. The similar description applies to terms with other “substantially”. Further, each drawing is a schematic diagram, and is not necessarily strictly illustrated.

In the drawings, unless otherwise specified, “upper” means the upper direction or the upper side in the drawings, “lower” means the lower direction or the lower side in the drawings, “left” means the left direction or the left side in the drawings, and “right” means the right direction or the right side in the drawings. Further, in the drawings, the same or equivalent elements or members are denoted by the same reference numerals, and redundant description is omitted.

The description will be given in the following order.
1. First Embodiment (Example 1 of Image Display Device)
(1) Overview
(2) Image light generation unit
(3) Light guide plate
(4) Detection unit
(5) Design value
2. Second Embodiment (Example 2 of Image Display Device)
3. Third Embodiment (Example 3 of Image Display Device)
4. Fourth Embodiment (Example 4 of Image Display Device)
5. Fifth Embodiment (Example 5 of Image Display Device)
6. Sixth Embodiment (Example of Light Guide Plate)

### 1. First Embodiment (Example 1 of Image Display Device)

### <(1) Overview>

The present technology provides an image display device including an image light generation unit that generates an image light, a light guide plate that guides the image light to an eyeball of a user, and a detection unit that detects eyeball information that is information associated with the eyeball. The image light generation unit is configured to be capable of switching a plurality of the image lights to be emitted to the light guide plate on the basis of the eyeball information, and the light guide plate includes at least a substrate that totally reflects and guides the image light incident, and a deflection part that condenses the image light to a rotation center of the eyeball.

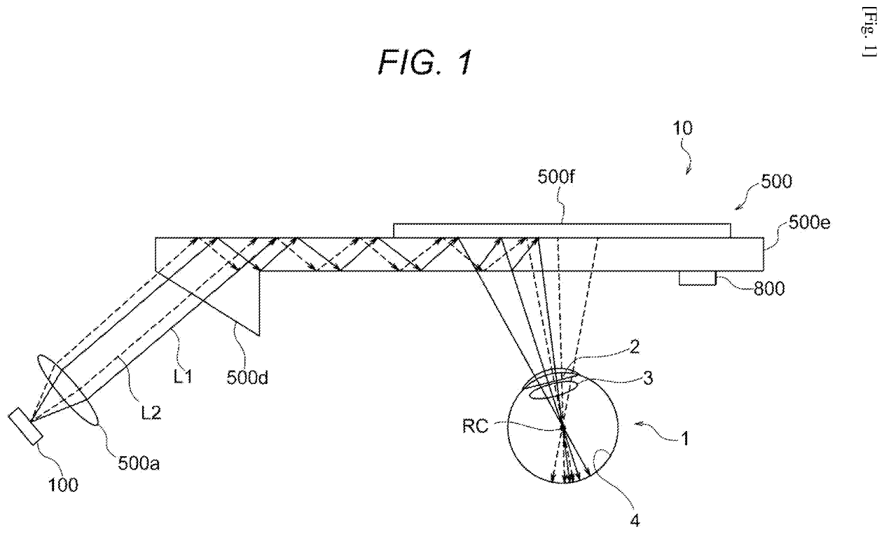

An image display device according to a first embodiment of the present technology will be described with reference to FIG. 1. FIG. 1 is a schematic diagram illustrating a configuration example of an image display device 10 according to the first embodiment of the present technology. As illustrated in FIG. 1, the image display device 10 includes an image light generation unit 100 and a light guide plate 500. The image light generation unit 100 may also be referred herein to as an image generator 100, and the light guide plate 500 may also be referred to herein as an image output device 500. In general, and as discussed in more detail herein, an image generator 100 generates and actively adjusts light traveling along an optical path to the image output device 500 based on eyeball information.

The image display device 10 is used for realizing XR including, for example, AR, VR, MR, and the like. The image display device 10 functions as, for example, a head mounted display (HMD) used by being mounted on the head of the user. The HMD is also called eyewear, for example. Note that the image display device 10 may be disposed at a predetermined place as an infrastructure.

### <(2) Image Light Generation Unit>

The image light generation unit 100 generates an image light and emits the image light toward the light guide plate 500. The image light generation unit 100 emits the image light obtained by converting angle of view information into space (position) information. The image light generation unit 100 may include, for example, laser beam scanning (LBS), liquid crystal on silicon (LCOS), a micro organic light emitting diode (M-OLED), a micro light-emitting diode (M-LED), or the like.

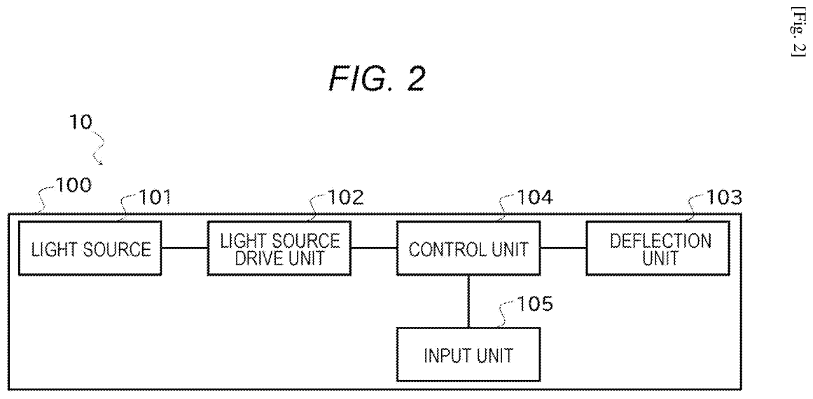

A configuration example of the image light generation unit 100 will be described with reference to FIG. 2. FIG. 2 is a block diagram illustrating a configuration example of the image display device 10 according to the first embodiment of the present technology. As illustrated in FIG. 2, the image light generation unit 100 may include a light source 101, a light source drive unit 102, a deflection unit 103, an input unit 105, and a control unit 104. The control unit 104 may be referred to herein as a controller 104 and include computer processing capabilities.

The light source 101 may be, for example, a laser light source or the like. Examples of the laser light source include semiconductor lasers such as an edge emitting laser (EEL), a surface emitting laser (SEL), and the like.

The light source drive unit 102 drives the light source 101. The light source drive unit 102 may be, for example, a laser driver or the like. The light source drive unit 102 drives the light source 101 on the basis of modulation data to be described later transmitted from the control unit 104. That is, the control unit 104 controls the light source 101 via the light source drive unit 102.

The deflection unit 103 includes one or more controllable devices, such as, movable mirrors movable around two axes orthogonal to each other (for example, one axis perpendicular to the paper surface of FIG. 1 and another axis orthogonal to the one axis), such as a MEMS mirror, a galvanometer mirror, a polygon mirror, and the like. Note that the deflection unit 103 may include a first movable mirror movable around one axis and a second movable mirror movable around another axis orthogonal to the one axis. The deflection unit 103 is controlled by the control unit 104. The control unit 104 controls the deflection unit 103 in synchronization with the control of the light source 101. That is, in the image light generation unit 100, light from the light source 101 driven according to the modulation data is deflected by the deflection unit 103, and image light is generated. Stated another way, the deflection unit 103 may include a movable mirror that actively adjusts a direction of the light traveling along the optical path to the image output device 500.

Information associated with an image to be displayed by the image display device 10 is input to the input unit 105. For example, image data, a three-dimensional object, and the like are input to the input unit 105. The input unit 105 may correspond to an electrical input of the image generator 100 that receives an image or video signal.

The control unit 104 includes a main controller that integrally controls the entire image display device 10. The control unit 104 is implemented by hardware such as a central processing unit (CPU), a chip set, or the like. The control unit 104 generates the modulation data on the basis of image data input from an external device or input via a network, and transmits the modulation data to the light source drive unit 102.

The description returns to FIG. 1. A lens 500a is disposed on optical paths of image lights L1 and L2 emitted from the image light generation unit 100, and light for each pixel is incident thereon. The image lights L1 and L2 emitted from the image light generation unit 100 become substantially parallel light by the lens 500a and are incident on an incident part 500d included in the light guide plate 500. Accordingly, the lens 500a may be referred to herein as a collimating lens 500a.

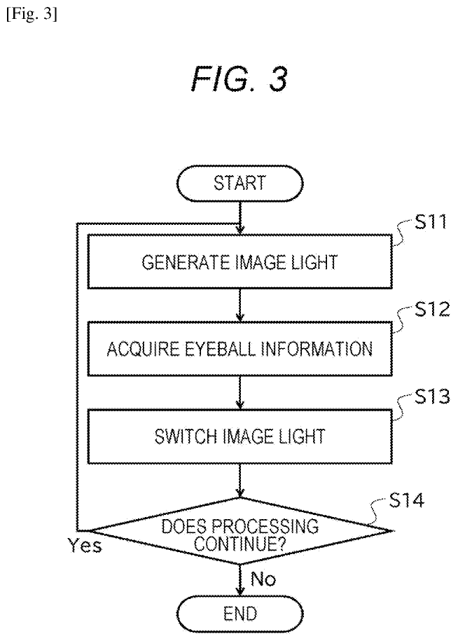

Processing of the image light generation unit 100 according to the first embodiment of the present technology will be described with reference to FIG. 3. FIG. 3 is a flowchart illustrating an example of processing of the image light generation unit 100 according to the first embodiment of the present technology. The image light generation unit 100 is started, for example, when a power switch of the image display device 10 is turned on.

In the first step S11, the control unit 104 generates an image light. Specifically, the control unit 104 synchronously controls the light source 101 and the deflection unit 103, and the deflection unit 103 deflects and scans the light emitted from the light source 101 to generate the image light. As a result, the image light reaches a retina 4 via a pupil 2 and a lens 3 of the user. Thus, the user can visually recognize the image.

In the next step S12, the control unit 104 acquires eyeball information. Specifically, the control unit 104 acquires the eyeball information from a detection unit 800 (also referred to as an eye tracking device 800). The eyeball information includes line-of-sight information.

In the next step S13, the control unit 104 switches the image light on the basis of the line-of-sight information included in the eyeball information. Specifically, for example, the control unit 104 synchronously controls the light source 101 and the deflection unit 103 so as to switch the image light L1 to the image light L2, and the deflection unit 103 deflects and scans the light emitted from the light source 101.

In the next step S14, the control unit 104 determines whether or not to continue the processing. Specifically, as an example, the control unit 104 determines to continue the processing when the power switch of the image display device 10 remains on, and determines not to continue the processing when the power switch is turned off. When the determination in step S14 is affirmative, the process proceeds to step S11, and when the determination is negative, the flow ends.

### <(3) Light Guide Plate>

The description returns to FIG. 1. The light guide plate 500 guides the image lights L1 and L2 incident from the incident part 500d to an eyeball 1 of the user. Specifically, the light guide plate 500 includes at least a substrate 500e that totally reflects and guides the incident image light, and a deflection part 500f that emits the image light to the eyeball 1 of the user who is an observer. The substrate 500e may also be referred to herein as a light guide 500e, and the deflection part 500f may also be referred to herein as an optical component 500f.

The substrate 500e may include, for example, transparent or translucent or opaque plastic, glass, resin, or the like. The substrate 500e may be a type (spectacle lens type) fitted into a spectacle frame as a support structure, or may be a type (combiner type) externally attached to the spectacle frame. In a case where AR is provided to the user, a transparent or translucent glass plate may be used as the substrate 500e. In a case where VR is provided to the user, an opaque glass plate may be used as the substrate 500e.

As an example, the deflection part 500f may be a transmission type or reflection type diffractive optical element. In the present embodiment, the deflection part 500f is a reflection type diffractive optical element, and is disposed on a surface of the substrate 500e opposite to the eyeball 1 side. The deflection part 500f is disposed on the optical paths of the image lights L1 and L2 from the image light generation unit 100. The deflection part 500f diffracts the image lights L1 and L2 from the image light generation unit 100 toward the eyeball 1. The image lights L1 and L2 are incident on the pupil 2 of the eyeball 1 and reach the retina 4 via the lens 3.

At this time, it is preferable that the deflection part 500f condenses the image lights L1 and L2 in the eyeball 1, for example, at a predetermined area of the eyeball which may correspond to a location that is at or near a rotation center RC of the eyeball 1 (e.g., within 1.7 mm of the rotation center RC). That is, the deflection part 500f is preferably a diffractive optical element that diffracts the image light to the rotation center of the eyeball 1. Alternatively, the deflection part 500f may be a reflection optical element that reflects the image light to the rotation center of the eyeball 1. With such elements, even if a line-of-sight direction of the user changes (even if the eyeball 1 rotates), the image lights L1 and L2 can be made incident on the pupil 2, and it is possible to cause the user to visually recognize the image.

In addition, a peripheral image at which the user is not gazing is vignetted by the pupil and does not reach the retina. As a result, deterioration in image quality due to stray light can be reduced.

Note that the deflection part 500f may be disposed on the surface of the substrate 500e on the eyeball 1 side. At this time, the deflection part 500f may be a transmission type diffractive optical element.

The incident part 500d and the deflection part 500f may be, for example, a holographic grating (HG), a half mirror, a lens, a surface relief grating (SRG), a volume phase holographic grating (VPHG), or the like. In a case where the VPHG is used, a plurality of diffraction gratings may be formed on the same plane, or a plurality of diffraction gratings may be stacked.

The light guide plate 500 is disposed at a position facing the eyeball 1. With such a configuration, the user can visually recognize the image generated by the image light generation unit 100.

The length of the deflection part 500f in the left-right direction (light guiding direction of the image light) in the drawing is proportional to the angle of view of the image visually recognized by the user. Therefore, to increase the angle of view, the length of the deflection part 500f is further increased in the left-right direction.

In the past, when the image light incident from the incident part 500d travels while being totally reflected inside the substrate 500e, part of the image light having the same information may hit the deflection part 500f a plurality of times. Therefore, part of the image light having the same information is deflected a plurality of times at positions having different powers of the deflection part 500f. As a result, the image light having the same information is incident on the eyeball at a plurality of angles. Such image light is observed as stray light.

To prevent such stray light, in the past, the length (thickness) of the substrate 500e in the vertical direction in FIG. 1 is increased. This structure prevents part of the image light having the same information from hitting the deflection part 500f a plurality of times.

However, as the thickness of the substrate 500e increases, the weight and volume of the image display device 10 increase. As a result, wearing the image display device 10 for a long time becomes difficult, whereby a feeling of immersion may be impaired. In addition, since a heavy object exists at a position away from the center of the user's head, the moment load increases. This may cause a problem with wearability. For example, since the moment load becomes larger when the user operates, a mounting deviation of the image display device 10 may occur.

In addition, as the thickness of the substrate 500e increases, the eye relief, which is the distance between the light guide plate 500 and the eyeball 1, becomes shorter. As a result, the user's eyelashes may hit the substrate 500e, or it may be difficult to wear the image display device 10 while wearing the glasses.

Furthermore, as the thickness of the substrate 500e increases, the light transmittance of the substrate 500e may decrease, or optical aberration may occur. As a result, for example, when an image displayed by the image display device 10 is superimposed on a landscape of the outside world, the quality of the image may be deteriorated.

Therefore, it is preferable to contribute to downsizing of the image display device 10 by preventing part of the image light having the same information from hitting the deflection part 500f a plurality of times without increasing the thickness of the substrate 500e.

For example, Patent Literature 1 (WO 2021/220638 A) discloses “A display device including: a light emission system that emits image light including a plurality of light beams having different wavelengths; a light guide system that guides the image light emitted from the light emission system; and a light deflection system that deflects the plurality of light beams included in the image light guided by the light guide system and causes the plurality of light beams to enter an eyeball from different directions.”. There is room for improvement in downsizing of the display device.

For example, Patent Literature 2 (JP H6-308422 A) discloses a visual display device that provides an image with high resolution only in a portion particularly requiring resolution near a gaze point and can observe a peripheral image that is not gazed without vignetting. In this visual display device, light with large aberration and uneven brightness may be incident on a portion other than the gaze point. In addition, to provide a visual display device with a wide observation angle of view and high resolution, the optical system may be increased in size. In addition, since a concave mirror is used, or an eyepiece optical system and a conjugate pupil position need to be set at the same position, the optical system may be increased in size. Furthermore, there is room for improvement in free focus.

The image display device 10 according to the first embodiment of the present technology includes the detection unit 800, which detects eyeball information that is information associated with an eyeball. The image light generation unit 100 is configured to be able to switch the plurality of image lights L1 and L2 emitted to the light guide plate 500 on the basis of the line-of-sight information included in the eyeball information detected by the detection unit 800. Specifically, the image light generation unit 100 is configured to be able to switch the image light L1 to the image light L2, for example.

The line-of-sight information is a direction in which the eyeball faces an object when the user looks at the object. The line-of-sight information can be defined as an axis indicating a direction in which eyes are generally directed, such as a visual axis, an optical axis, an eye axis, an aiming line and the like. The present technology uses these pieces of information obtained directly or indirectly. Note that, as is widely known, the line-of-sight information can be indirectly calculated from the positional information of the eyeball or the like.

Each of the plurality of image lights has, for example, a different range of an image to be visually recognized by the user. With this difference, even if the angle of view is reduced by decreasing the thickness of the substrate 500e to achieve downsizing of the device, it is possible to cause the user to visually recognize the image. For example, when the eyeball rotates in the left direction, the image to be visually recognized by the user is also switched to the image in the left direction. Therefore, in the present technology, it is possible to cause the user to visually recognize an image with a sufficient visual field. Note that the image light generation unit 100 may mechanically or electrically switch the image light.

Note that the light guiding position may be switched by increasing the area of the incident part 500d and changing the position where the image light generation unit 100 is disposed. Alternatively, robustness with respect to the mounting deviation may be secured by switching the image according to a positional deviation of the eyeball 1.

According to the embodiments of the present technology, the thickness of the substrate 500e can be decreased. Even in the substrate 500e having a relatively low refractive index, the thickness can be decreased. Since the angle of view can be reduced by switching the image by the image light generation unit 100, the pixel density is improved. In addition, although details will be described later, since the adjustment range of the eye relief can be increased, the degree of freedom in designing the image display device 10 is improved.

Furthermore, it is possible to prevent a decrease in light transmittance of the substrate 500e and the occurrence of optical aberration due to a decrease in the thickness of the substrate 500e. As a result, for example, when an image displayed by the image display device 10 is superimposed on a landscape of the outside world or this image is superimposed on an image with a wider angle of view, it is possible to reduce deterioration in the quality of the image.

These effects similarly occur in other embodiments described later. Therefore, in other embodiments, the repetitive description thereof may be omitted.

### <(4) Detection Unit>

As an example, the detection unit 800 is provided on the surface of the substrate 500e on the eyeball 1 side. The detection unit 800 detects eyeball information such as a line-of-sight and the like that is a direction of the eyeball 1 of the user, and outputs the eyeball information to the control unit 104 (see FIG. 2). The detection unit 800 includes, for example, a light receiving/emitting unit and a signal processor that processes an output signal of the light receiving/emitting unit. The light receiving/emitting unit includes a light emitting element that irradiates the eyeball 1 with invisible light (for example, infrared light) and a light receiving element that receives light emitted from the light emitting element and reflected by the eyeball 1. As the light receiving element, for example, a photodiode, a divided photodiode having a plurality of light receiving regions, an image sensor, an event-type sensor (sensor for eye sensing), or the like can be used. The signal processor processes the output signal of the light receiving element described above and calculates the direction of the line-of-sight.

The eyeball information detected by the detection unit 800 preferably includes a pupil diameter of the eyeball 1. At this time, the detection unit 800 can include an illuminance sensor. The detection unit 800 estimates the pupil diameter of the pupil 2 of the eyeball 1 on the basis of the output of the illuminance sensor.

More specifically, as an example, a table indicating the correspondence relationship between the illuminance and the pupil diameter may be stored in a built-in memory in advance. The detection unit 800 refers to this table as needed and outputs the pupil diameter corresponding to the output of the illuminance sensor as an estimation result. The table can be obtained by calculating an average value, a median value, and the like of pupil diameters of a plurality of persons at each illuminance when the illuminance is changed in stages using, for example, a light source and a camera.

The eyeball information may further include the eye relief, which is the distance from the deflection part 500f to a corneal vertex of the eyeball 1, or the distance from the corneal vertex of the eyeball 1 to the rotation center of the eyeball 1, or both. At this time, the eyeball information may be detected by the detection unit 800 or may be recorded in a memory or the like included in the image display device 10.

The image light generation unit 100, the light guide plate 500, and the detection unit 800 can be integrally provided in the same support structure (for example, a spectacle frame) as an example. The detection unit 800 may be provided integrally with the support structure or may be provided separately. Hereinafter, a description will be given on the premise that a spectacle frame as an example of the support structure is mounted on the head of the user.

### <(5) Design Value>

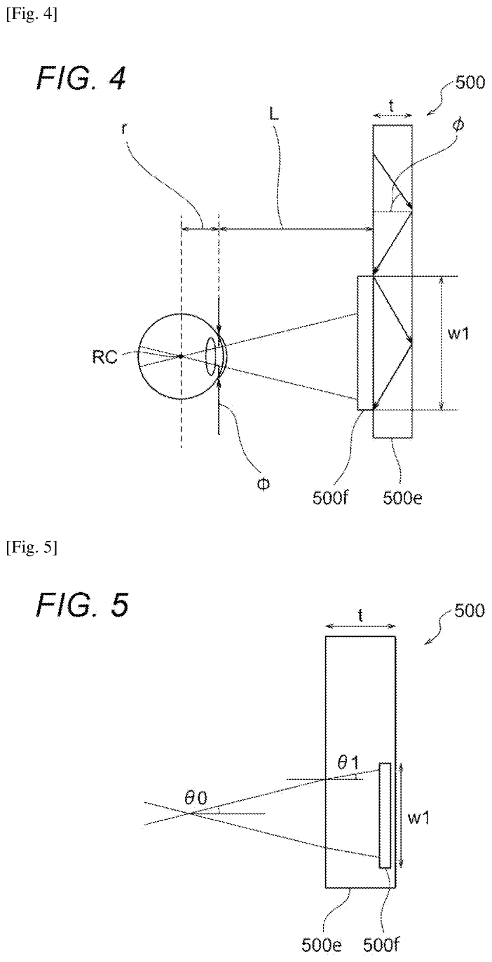

Preferable design values of the light guide plate 500 to achieve downsizing of the device will be described with reference to FIG. 4. FIG. 4 is a schematic diagram illustrating a correlation between the light guide plate 500 and the eyeball 1 according to the first embodiment of the present technology.

As illustrated in FIG. 4, the deflection part 500f is formed on the eyeball 1 side of the substrate 500e. The incident angle of image light to the light guide plate 500 is q. The eye relief, which is the distance from the deflection part 500f to the corneal vertex of the eyeball 1, is L. The distance from the corneal vertex of the eyeball 1 to the rotation center RC of the eyeball is r. The pupil diameter of the eyeball 1 is Φ. The thickness of the substrate 500e is t. The length of the deflection part 500f in a direction (vertical direction in FIG. 4) in which the image light is guided in the substrate 500e is w1. At this time, it is preferable to satisfy the following Expressions (1), (2), and (3).

tan θ=Φ/(2*r) (1)

w1=2*(L+r)tan θ (2)

2*t*tan φ>w1 (3)

At this time, the following Expression (4) can be derived from Expressions (1) and (2).

w1=2*(L+r)*Φ/(2*r) (4)

Furthermore, the following Expressions (5) and (6) can be derived from Expressions (3) and (4).

2*t*tan φ>2*(L+r)*Φ/(2*r) (5)

t>(L+r)*Φ/(2*r*tan φ) (6)

Therefore, downsizing of the image display device 10 can be achieved by being provided with the light guide plate 500 satisfying Expression (6). The distance r from the corneal vertex of the eyeball 1 to the rotation center of the eyeball and the pupil diameter Φ are generally fixed although there are individual differences. On the other hand, the eye relief L, the thickness t of the substrate 500e, and the incident angle Φ can be controlled.

On the other hand, preferable values of the light guide plate 500 when the deflection part 500f is formed on the substrate 500e on the side opposite to the eyeball 1 will be described with reference to FIG. 5. FIG. 5 is a schematic diagram illustrating a correlation between the light guide plate 500 and the eyeball 1 according to the first embodiment of the present technology.

As illustrated in FIG. 5, the deflection part 500f is formed on the substrate 500e on the side opposite to the eyeball 1 side.

The half angle of view (half angle of view) visually recognized by the user is θ0. The angle of view of the image light in the substrate 500e is θ1. The other symbols are the same as the symbols in FIG. 4.

At this time, it is preferable to satisfy the following Expressions (7), (8), and (9).

tan θ0=Φ/(2*r) (7)

w1=2*(L+r)tan θ0+2*t*tan θ1 (8)

2*t*tan φ>w1 (9)

At this time, the following Expression (10) can be derived from Expressions (7) and (8).

w1=2*(L+r)*Φ/(2*r)+2*t*tan θ1 (10)

Furthermore, the following Expressions (11), (12), (13), (14), and (15) can be derived from Expressions (9) and (10).

2*t*tan φ>2*(L+r)*Φ/(2*r)+2*t*tan θ1 (11)

t*tan φ>(L+r)*Φ/(2*r)+t*tan θ1 (12)

t*tan φ−t*tan θ1>(L+r)*Φ/(2*r) (13)

t*(tan φ−tan θ1)>(L+r)*Φ/(2*r) (14)

t>(L+r)*Φ/(2*r*(tan φ−tan θ1)) (15)

Therefore, downsizing of the image display device 10 can be achieved by being provided with the light guide plate 500 satisfying Expression (15). The distance r from the corneal vertex of the eyeball 1 to the rotation center of the eyeball and the pupil diameter Φ are generally fixed although there are individual differences. On the other hand, the eye relief L, the thickness t of the substrate 500e, the incident angle φ, and the angle of view of the image light in the substrate 500e can be controlled.

Effects of the present technology will be described with reference to Tables 1 and 2. In a case where the eye relief is the same, Table 1 shows the respective values in the examples and the comparative examples. Note that, in Tables 1 and 2, the pupil diameter is defined as 3 mm.

TABLE 1

| | Comparative example | Example |
|---|---|---|
| Incident angle φ [degree] | 55 | 55 |
| Angle of view [±] | 30 | 7.1 |
| Eye relief L [mm] | 14 | 14 |
| Distance r [mm] | 0 | 9.4 |
| Length w1 of deflection part [mm] | 16.2 | 6.0 |
| Thickness t [mm] | 5.7 | 2.1 |

The incident angle φ of the image light on the light guide plate 500 is 55 degrees in both the comparative example and the example.

The angle of view to be visually recognized by the user is ±30 in the comparative example and ±7.1 in the example. By decreasing the thickness of the substrate 500e, the angle of view in the example is narrower than that in the comparative example. However, in the present technology, the image light generation unit 100 is configured to be able to switch the plurality of image lights to be emitted to the light guide plate 500 on the basis of the eyeball information detected by the detection unit 800. Therefore, in the present technology, for example, the angle of view to be visually recognized can be changed according to the line-of-sight.

The eye relief L is 14 mm in both the comparative example and the example.

The distance r from the corneal vertex of the eyeball 1 to the rotation center of the eyeball, which needs to be considered in the present technology, is defined as 9.4 mm.

The length w1 of the deflection part 500f in the direction in which the image light is guided in the substrate 500e is 16.2 mm in the comparative example and 6.0 mm in the example.

The thickness t of the substrate 500e is 5.7 mm in the comparative example and 2.1 mm in the example. According to the present technology, the thickness t of the substrate 500e can be reduced to half or less. As a result, the length w1 of the deflection part 500f in the direction in which the image light is guided in the substrate 500e can also be reduced to half or less.

Next, in a case where the thickness of the substrate 500e is the same, Table 2 shows the respective values in the examples and the comparative examples.

TABLE 2

| | Comparative example | Example |
|---|---|---|
| Incident angle φ [degree] | 55 | 55 |
| Angle of view [±] | 30 | 7 |
| Distance r [mm] | 0 | 12 |
| Length w1 of deflection part [mm] | 16.2 | 16.2 |
| Thickness t [mm] | 5.7 | 5.7 |
| Eye relief L [mm] | 14 | 53 |

The incident angle φ of the image light on the light guide plate 500 is 55 degrees in both the comparative example and the example.

The angle of view to be visually recognized by the user is ±30 in the comparative example and ±7 in the example.

The distance r from the corneal vertex of the eyeball 1 to the rotation center of the eyeball, which needs to be considered in the present technology, is defined as 12 mm.

The length w1 of the deflection part 500f in the direction in which the image light is guided in the substrate 500e is 16.2 mm in both the comparative example and the example.

The thickness t of the substrate 500e is 5.7 mm in both the comparative example and the example.

The eye relief L is 14 mm in the comparative example and 53 mm in the example. According to the present technology, the adjustment range of the eye relief L can be expanded. With this expansion, the user's eyelashes can be prevented from hitting the substrate 500e, or the image display device 10 can be mounted while wearing the glasses.

Subsequently, a preferable numerical range of each component will be described. According to Non-Patent Literature 1 and Non-Patent Literature 2 below, the distance r from the corneal vertex of the eyeball 1 to the rotation center of the eyeball is generally 9.4 mm although there are individual differences.

Non-Patent Literature 1: Jim Schwiegerling, “SPIE Field Guide to Visual and Ophthalmic Optics”, Optronics, Inc., Dec. 15, 2010

Non-Patent Literature 2: Fry G, Hill W, Center of rotation of the eye, Am J Optom Arch Am Acad Optom 1962, 39:581-95

In addition, according to Non-Patent Literature 3 below, it is stated that the distance r from the corneal vertex of the eyeball 1 to the rotation center of the eyeball is 10.781±0.56 mm±1 SD (10.22 to 11.34 mm). In this case, considering ±3 SD, the maximum range of the distance r from the corneal vertex of the eyeball 1 to the rotation center of the eyeball can be assumed to be 9.1 to 12.46 mm.

Therefore, the range of the distance r from the corneal vertex of the eyeball 1 to the rotation center of the eyeball is preferably defined as 9.1 to 12.46 mm, and can be more preferably 9.4 to 11.34 mm.

The pupil diameter Φ of a human is generally 2.0 to 8.0 mm. However, since there is almost no situation where the luminance is 1 cd/m2 or less in an actual video, the pupil diameter of a human is preferably defined as 2.0 to 5.0 mm.

When the general refractive index of the substrate 500e is 1.4, the incident angle φ of the image light to the light guide plate 500 is preferably 45.6 degrees or more. When the deflection part 500f is, for example, an HG, considering exposure, the incident angle φ of the image light on the light guide plate 500 is preferably 55 degrees or more.

According to these conditions, the preferable numerical range of each component can be shown as Table 3 and Table 4. Table 3 shows the preferable numerical range of each component when the deflection part 500f is formed on the eyeball 1 side of the substrate 500e. Table 4 shows the preferable numerical range of each component when the deflection part 500f is formed on the substrate 500e on the side opposite to the eyeball 1 side.

TABLE 3

| | | More | More | |
|---|---|---|---|---|
| | Preferable | Preferable | preferable | Preferable |
| | minimum | minimum | maximum | maximum |
| | value | value | value | value |
| Pupil diameter | 2 | 2.5 | 2.5 | 5 |
| [mm] | | | | |
| Incident angle | 55 | 55 | 55 | 55 |
| φ [degree] | | | | |
| Angle of view | 6.3 | 5.7 | 7.6 | 11.3 |
| [±] | | | | |
| Eye relief L | 13 | 13 | 13 | 13 |
| [mm] | | | | |
| Distance r [mm] | 9.1 | 9.4 | 12.46 | 12.46 |
| Length w1 of | 4.9 | 5.1 | 6.0 | 10.2 |
| deflection part | | | | |
| [mm] | | | | |
| Thickness t [mm] | 0.2 | 1.8 | 2.1 | 3.6 |

As shown in Table 3, the pupil diameter Φ is preferably defined as 2 to 5 mm, and may be more preferably 2.5 mm.

The incident angle φ of the image light on the light guide plate 500 is preferably 55 degrees.

The angle of view recognized by the user may preferably be ±5.7 to ±11.2, and more preferably ±6.3 to ±7.6.

The eye relief L is preferably 13 mm.

The distance r from the corneal vertex of the eyeball 1 to the rotation center of the eyeball is preferably defined as 9.1 to 12.46 mm, and may be more preferably 9.4 to 12.46 mm.

The length w1 of the deflection part 500f may be preferably 4.9 to 10.2 mm, and more preferably 5.1 to 6.0 mm.

At this time, the thickness t of the substrate 500e may be 0.2 to 3.6. The thickness t of the substrate 500e may be more preferably 1.8 to 2.1.

TABLE 4

| | | More | More | |
|---|---|---|---|---|
| | Preferable | Preferable | preferable | Preferable |
| | minimum | minimum | maximum | maximum |
| | value | value | value | value |
| Pupil diameter | 2 | 2.5 | 2.5 | 5 |
| [mm] | | | | |
| Incident angle φ | 55 | 55 | 55 | 55 |
| [degree] | | | | |
| Angle of view | 6.3 | 5.7 | 7.6 | 11.3 |
| [±] | | | | |
| Eye relief L [mm] | 13 | 13 | 13 | 13 |
| Distance r [mm] | 9.1 | 9.4 | 12.46 | 12.46 |
| Length w1 of | 4.9 | 5.5 | 6.6 | 11.9 |
| deflection part | | | | |
| [mm] | | | | |
| Thickness t [mm] | 0.2 | 1.9 | 2.3 | 4.2 |

As shown in Table 4, the pupil diameter Φ is preferably defined such that an assumed minimum value is 2 to 5 mm, and may be more preferably 2.5 mm.

The incident angle φ of the image light on the light guide plate 500 is preferably 55 degrees.

The angle of view recognized by the user may preferably be ±5.7 to ±11.3, and more preferably ±6.3 to ±7.6.

The eye relief L is preferably 13 mm.

The distance r from the corneal vertex of the eyeball 1 to the rotation center of the eyeball is preferably defined as 9.1 to 12.46 mm, and may be more preferably 9.4 to 12.46 mm.

The length w1 of the deflection part 500f may be preferably 4.9 to 11.9 mm, and more preferably 5.5 to 6.6 mm.

At this time, the thickness t of the substrate 500e may be 0.2 to 4.2. The thickness t of the substrate 500e may be more preferably 1.9 to 2.3.

The contents described above for the image display device according to the first embodiment of the present technology can be applied to other embodiments of the present technology as long as there is no technical contradiction.

### 2. Second Embodiment (Example 2 of Image Display Device)

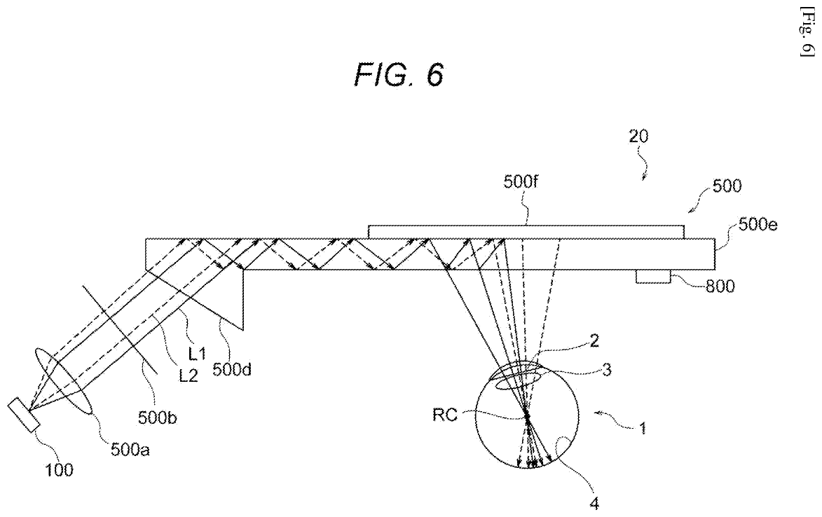

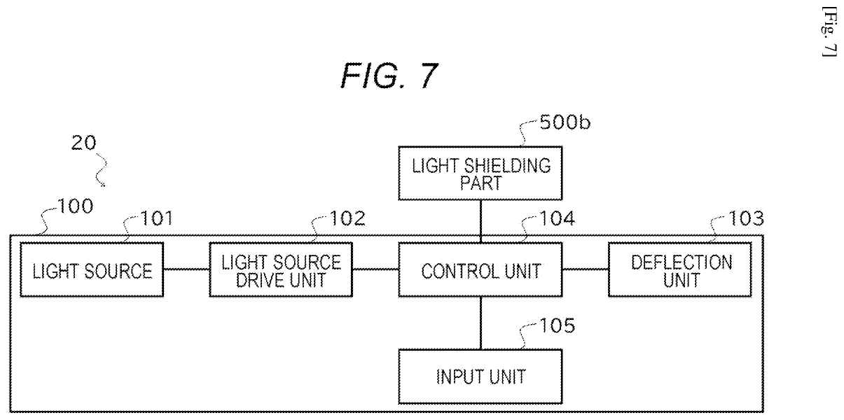

The image display device according to a second embodiment of the present technology may further include a light shielding part that shields part of the image light emitted by the image light generation unit. This will be described with reference to FIGS. 6 and 7. FIG. 6 is a schematic diagram illustrating a configuration example of an image display device 20 according to the second embodiment of the present technology. FIG. 7 is a block diagram illustrating a configuration example of the image display device 20 according to the second embodiment of the present technology. As illustrated in FIGS. 6 and 7, the image display device 20 further includes a light shielding part 500b (also referred to herein as a light shield 500b controllable to selectively block light). Stated another way, the light shield 500b is a controllable device that actively adjusts an amount of the light traveling along the optical path to the image output device 500.

The image lights L1 and L2 are incident on the light shielding part 500b via the lens 500a. The light shielding part 500b transmits predetermined image light and shields predetermined image light of the incident image light. For example, the light shielding part 500b transmits the image light L1 and shields the image light L2.

As an example, the light shielding part 500b may include any of a light shielding mask (for example, a light shielding shutter), a liquid crystal element (for example, a liquid crystal panel), and a digital mirror device (DMD) capable of shielding the incident image light for each pixel or each pixel block including a plurality of pixels. The light shielding part 500b can be controlled by the control unit 104 (see FIG. 7). More specifically, the light shielding part 500b is controlled by the control unit 104 so as to transmit predetermined image light and shield (or block) predetermined image light of the incident image light.

Preferably, the light shielding part 500b can have a spatial distribution in the light shielding degree. With such a distribution, for example, the light shielding degree of the edge portions of the image lights L1 and L2 to be shielded can be lowered. As a result, the boundary between the image lights L1 and L2 guided to the eyeball 1 of the user can be blurred. As a result, it is possible to cause the user to visually recognize the image as a more natural image.

It is preferable that the light shielding part 500b can shield the image light and cancel the shielding of the image light in time series. For example, by performing shielding of the image light and cancellation of the shielding of the image light by the light shielding part 500b in time series, guiding the line-of-sight of the user may be performed as necessary. The light shielding part 500b and the deflection unit 103 may each be referred to herein as a controllable device capable of actively adjusting light traveling along an optical path to the image output device 500. It should be appreciated that the light shielding part 500b may be operated with or without the deflection unit 103 to actively adjust light traveling from the image generator 100 to the image output device 500.

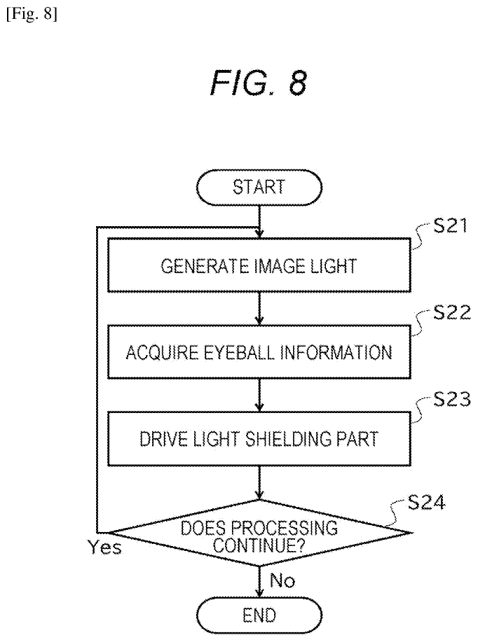

Processing of the image light generation unit 100 according to the second embodiment of the present technology will be described with reference to FIG. 8. FIG. 8 is a flowchart illustrating an example of processing of the image light generation unit 100 according to the second embodiment of the present technology. The image light generation unit 100 is started, for example, when a power switch of the image display device 20 is turned on.

In the first step S21, the control unit 104 generates an image light. Specifically, the control unit 104 synchronously controls the light source 101 and the deflection unit 103, and the deflection unit 103 deflects and scans the light emitted from the light source 101 to generate the image light. As a result, the image light reaches the retina 4 via the pupil 2 and the lens 3 of the user. Thus, the user can visually recognize the image.

In the next step S22, the control unit 104 acquires eyeball information. Specifically, the control unit 104 acquires the eyeball information from the detection unit 800.

In the next step S23, the control unit 104 drives the light shielding part 500b on the basis of the eyeball information. Specifically, the control unit 104 drives the light shielding part 500b so as to transmit predetermined image light and shield predetermined image light.

In the next step S24, the control unit 104 determines whether or not to continue the processing. Specifically, as an example, the control unit 104 determines to continue the processing when the power switch of the image display device 20 remains on, and determines not to continue the processing when the power switch is turned off. When the determination in step S24 is affirmative, the process proceeds to step S21, and when the determination is negative, the flow ends.

The contents described above on the image display device according to the second embodiment of the present technology can be applied to other embodiments of the present technology as long as there is no technical contradiction.

### 3. Third Embodiment (Example 3 of Image Display Device)

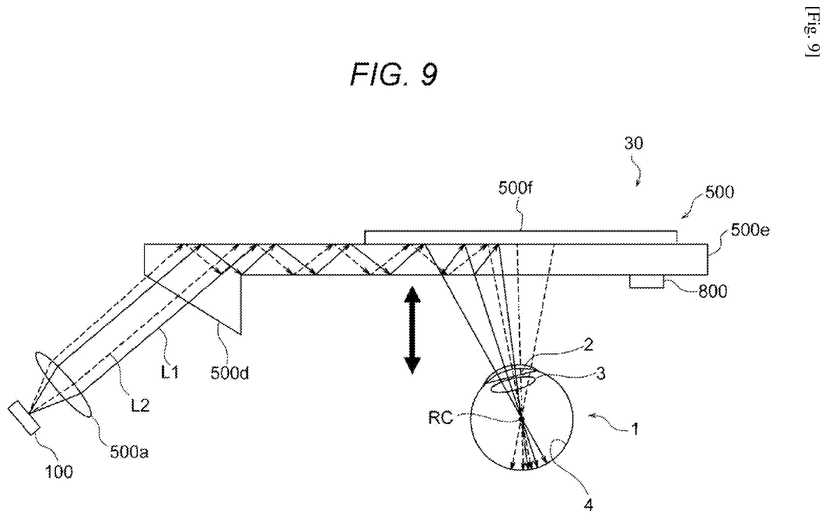

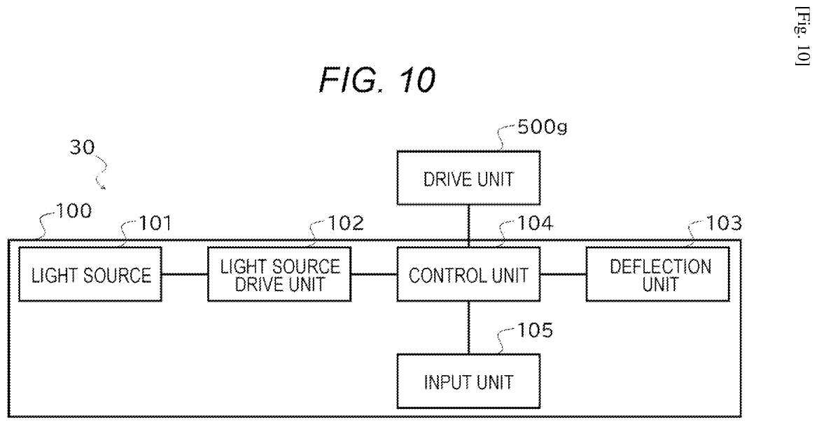

The image display device according to a third embodiment of the present technology may further include a drive unit that moves the light guide plate 500 in an eye relief direction that is a distance direction from the deflection part 500f to the corneal vertex of the eyeball 1. This will be described with reference to FIGS. 9 and 10. FIG. 9 is a schematic diagram illustrating a configuration example of an image display device 30 according to the third embodiment of the present technology. As illustrated in FIG. 9, the drive unit (not illustrated) can move the light guide plate 500 in the eye relief direction (vertical arrow direction), which is the distance direction from the deflection part 500f to the corneal vertex of the eyeball 1. Thus, the light guide plate 500 can be disposed at an appropriate position.

FIG. 10 is a block diagram illustrating a configuration example of the image display device 30 according to the third embodiment of the present technology. As illustrated in FIG. 10, the image display device 30 can include a drive unit 500g. The drive unit 500g can move the light guide plate 500 in the eye relief direction, which is the distance direction from the deflection part 500f to the corneal vertex of the eyeball 1. Stated another way, the image output device 500 is movable in a direction toward the eyeball of the user and away from the eyeball of the user.

The contents described above on the image display device according to the third embodiment of the present technology can be applied to other embodiments of the present technology as long as there is no technical contradiction.

### 4. Fourth Embodiment (Example 4 of Image Display Device)

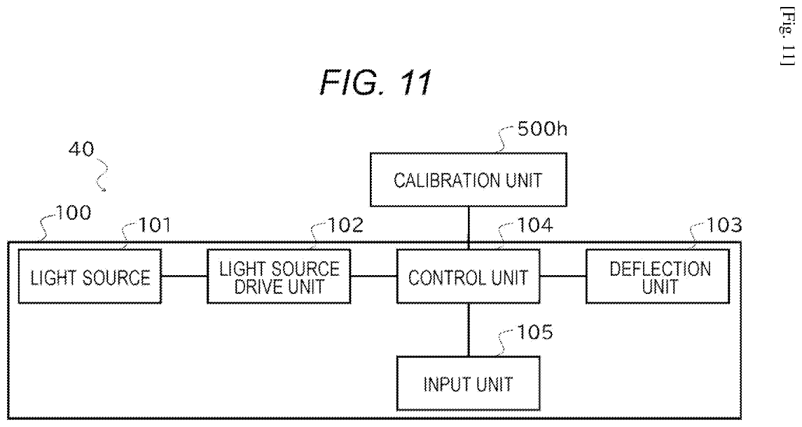

The image display device according to a fourth embodiment of the present technology may further include a calibration unit that acquires a deviation from a reference position of a user on the basis of a user operation on a calibration image including an image light. This will be described with reference to FIG. 11. FIG. 11 is a block diagram illustrating a configuration example of an image display device 40 according to the fourth embodiment of the present technology. As illustrated in FIG. 11, the image display device 40 can include a calibration unit 500h. The calibration unit 500h acquires a deviation from a reference position of the user on the basis of a user operation on the calibration image including the image light. The calibration unit 500h may be referred to as a calibration device 500h that determines the user's deviation from a reference position.

Means for acquiring such a deviation is not particularly limited. For example, the image display device 40 displays a calibration image on which a predetermined instruction mark is drawn to the user. The image display device 40 guides the line-of-sight, which is the direction of the eyeball of the user, by moving this instruction mark. The user performs a user operation such as moving the eyeball, moving the head direction, or the like. The calibration unit 500h acquires the deviation from the reference position of the user on the basis of this user operation. With this acquisition means, for example, when an image displayed by the image display device 40 is superimposed on a landscape of the outside world, the positional deviation can be reduced.

The contents described above on the image display device according to the fourth embodiment of the present technology can be applied to other embodiments of the present technology as long as there is no technical contradiction.

### 5. Fifth Embodiment (Example 5 of Image Display Device)

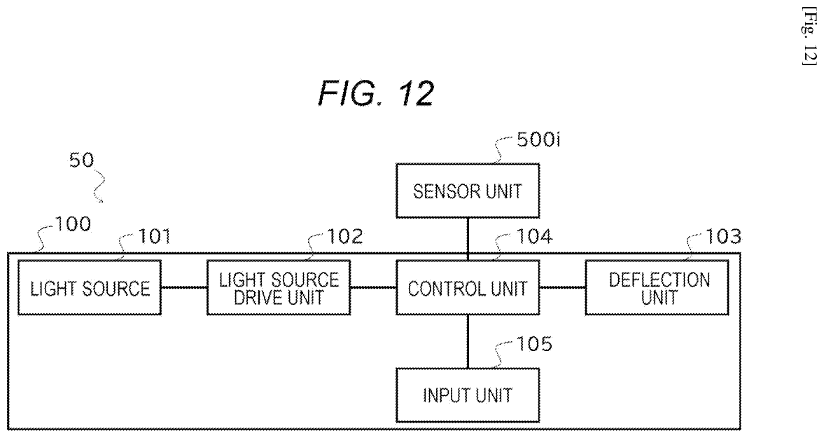

The image display device according to a fifth embodiment of the present technology may further include a sensor unit that acquires an eye relief L that is the distance from the deflection part 500f to the corneal vertex of the eyeball 1, or the distance r from the corneal vertex of the eyeball 1 to the rotation center of the eyeball, or both. This will be described with reference to FIG. 12. FIG. 12 is a block diagram illustrating a configuration example of an image display device 50 according to the fifth embodiment of the present technology. As illustrated in FIG. 12, the image display device 50 can include a sensor unit 500i. The sensor unit 500i acquires the eye relief L, which is the distance from the deflection part 500f to the corneal vertex of the eyeball 1, or the distance r from the corneal vertex of the eyeball 1 to the rotation center of the eyeball, or both. The sensor unit 500i may be, for example, an acceleration sensor, an angular velocity sensor, or the like. The sensor unit 500i may be referred to as a sensor for sensing a distance between the image output device 500 and a corneal vertex of the eyeball.

The contents described above on the image display device according to the fifth embodiment of the present technology can be applied to other embodiments of the present technology as long as there is no technical contradiction.

### 6. Sixth Embodiment (Example of Light Guide Plate)

The present technology provides a light guide plate including a substrate that totally reflects and guides an incident image light, a deflection part that condenses the image light on a rotation center of an eyeball, and a detection unit that detects eyeball information that is information associated with the eyeball, in which the deflection part condenses the image light switched on the basis of the eyeball information on the rotation center of the eyeball.

A light guide plate according to a sixth embodiment of the present technology will be described again with reference to FIG. 1. As illustrated in FIG. 1, the light guide plate 500 includes the substrate 500e, the deflection part 500f, and the detection unit 800.

The substrate 500e totally reflects and guides the incident image light. The deflection part 500f condenses the image light on the rotation center of the eyeball 1. The detection unit 800 detects eyeball information that is information associated with the eyeball 1. The deflection part 500f condenses the image light switched on the basis of the eyeball information at the rotation center of the eyeball 1.

A preferable value of the light guide plate 500 when the deflection part 500f is formed on the eyeball 1 side of the substrate 500e will be described again with reference to FIG. 4. As illustrated in FIG. 4, the deflection part 500f is formed on the eyeball 1 side of the substrate 500e. The incident angle of image light to the light guide plate 500 is φ. The eye relief, which is the distance from the deflection part 500f to the corneal vertex of the eyeball 1, is L. The distance from the corneal vertex of the eyeball 1 to the rotation center of the eyeball is r. The pupil diameter of the eyeball 1 is Φ. The thickness of the substrate 500e is t. The length of the deflection part 500f in the direction in which the image light is guided in the substrate 500e is w1.

At this time, it is preferable to satisfy the following Expressions (1), (2), and (3).

tan θ=Φ/(2*r) (1)

w1=2*(L+r)tan θ (2)

2*t*tan φ>w1 (3)

At this time, the following Expression (4) can be derived from Expressions (1) and (2).

w1=2*(L+r)*Φ/(2*r) (4)

Furthermore, the following Expressions (5) and (6) can be derived from Expressions (3) and (4).

2*t*tan φ>2*(L+r)*Φ/(2*r) (5)

t>(L+r)*Φ/(2*r*tan φ) (6)

Therefore, downsizing of the image display device 10 can be achieved by being provided with the light guide plate 500 satisfying Expression (6). The distance r from the corneal vertex of the eyeball 1 to the rotation center of the eyeball and the pupil diameter Φ are generally fixed although there are individual differences. On the other hand, the eye relief L, the thickness t of the substrate 500e, and the incident angle φ can be controlled.

On the other hand, a preferable value of the light guide plate 500 when the deflection part 500f is formed on the substrate 500e on the side opposite to the eyeball 1 will be described again with reference to FIG. 5. As illustrated in FIG. 5, the deflection part 500f is formed on the substrate 500e on the side opposite to the eyeball 1 side.

The half angle of view (half angle of view) visually recognized by the user is θ0. The angle of view of the image light in the substrate 500e is θ1. The other symbols are the same as the symbols in FIG. 4.

At this time, it is preferable to satisfy the following Expressions (7), (8), and (9).

tan θ0=Φ/(2*r) (7)

w1=2*(L+r)tan θ0+2*t*tan θ1 (8)

2*t*tan φ>w1 (9)

At this time, the following Expression (10) can be derived from Expressions (7) and (8).

w1=2*(L+r)*Φ/(2*r)+2*t*tan θ1 (10)

Furthermore, the following Expressions (11), (12), (13), (14), and (15) can be derived from Expressions (9) and (10).

2*t*tan φ>2*(L+r)*Φ/(2*r)+2*t*tan θ1 (11)

t*tan φ>(L+r)*Φ/(2*r)+t*tan θ1 (12)

t*tan−t*tan θ1>(L+r)*Φ/(2*r) (13)

t*(tan−tan θ1)>(L+r)*Φ/(2*r) (14)

t>(L+r)*Φ/(2*r*(tan φ−tan θ1)) (15)

Therefore, downsizing of the image display device 10 can be achieved by being provided with the light guide plate 500 satisfying Expression (15). The distance r from the corneal vertex of the eyeball 1 to the rotation center of the eyeball and the pupil diameter Φ are generally fixed although there are individual differences. On the other hand, the eye relief L, the thickness t of the substrate 500e, the incident angle φ, and the angle of view of the image light in the substrate 500e can be controlled.

The contents described above on the light guide plate according to the sixth embodiment of the present technology can be applied to other embodiments of the present technology as long as there is no technical contradiction.

Note that the embodiments according to the present technology are not limited to each of the above-described embodiments, and various modifications can be made without departing from the gist of the present technology.

Further, the present technology can also have the following configurations.

<1>

An image display device including:
an image light generation unit that generates an image light;
a light guide plate that guides the image light to an eyeball of a user; and
a detection unit that detects eyeball information that is information associated with an eyeball,
in which the image light generation unit is configured to be able to switch a plurality of the image lights to be emitted to the light guide plate on the basis of the eyeball information, and
the light guide plate includes at least
a substrate that totally reflects and guides the image light incident, and
a deflection part that condenses the image light at a rotation center of the eyeball.
   <2>

The image display device according to <1>,
in which the eyeball information includes line-of-sight information.
   <3>

The image display device according to one or more of <1> to <2>,
in which the eyeball information includes a pupil diameter of the eyeball.
   <4>

The image display device according to one or more of <1> to <3>,
in which the eyeball information further includes
an eye relief that is a distance from the deflection part to a corneal vertex of the eyeball,
a distance from the corneal vertex of the eyeball to the rotation center of the eyeball, or
both.
   <5>

The image display device according to one or more of <1> to <4>,
in which when the deflection part is formed on the eyeball side of the substrate, the following Expression (6) is satisfied,
where φ is an incident angle of the image light on the light guide plate,
L is an eye relief that is a distance from the deflection part to the corneal vertex of the eyeball,
r is a distance from the corneal vertex of the eyeball to the rotation center of the eyeball,
Φ is a pupil diameter of the eyeball, and
t is a thickness of the substrate.

t>(L+r)*Φ/(2*r*tan φ) (6)

<6>

The image display device according to one or more of <1> to <5>,
in which when the deflection part is formed on a side opposite to the eyeball side of the substrate, the following Expression (15) is satisfied,
where φ is an incident angle of the image light the light guide plate,
L is an eye relief that is a distance from the deflection part to the corneal vertex of the eyeball,
r is a distance from the corneal vertex of the eyeball to the rotation center of the eyeball,
Φ is a pupil diameter of the eyeball,
t is a thickness of the substrate, and
θ1 is an angle of view of the image light in the substrate.

t>(L+r)*Φ/(2*r*(tan φ−tan θ1)) (15)

<7>

The image display device according to one or more of <1> to <6>,
in which the deflection part is a diffractive optical element that diffracts the image light to the rotation center of the eyeball.
   <8>

The image display device according to one or more of <1> to <7>,
in which the deflection part is a holographic grating.
   <9>

The image display device according to one or more of <1> to <8>,
in which the deflection part is a surface relief grating.
   <10>

The image display device according to one or more of <1> to <9>,
in which the deflection part is a reflection optical element that reflects the image light to the rotation center of the eyeball.
   <11>

The image display device according to one or more of <1> to <10>,
further including a light shielding part that shields part of the image light emitted by the image light generation unit.
   <12>

The image display device according to one or more of <1> to <11>,
in which the light shielding part has a spatial distribution in a light shielding degree of the image light.
   <13>

The image display device according to one or more of <1> or <12>,
in which the light shielding part is configured to be able to shield the image light and cancel the shielding of the image light in time series.
   <14>

The image display device according to one or more of <1> to <13>,
in which the light shielding part is a mask with a light shielding position that is variable.
   <15>

The image display device according to one or more of <1> to <14>,
in which the light shielding part is a liquid crystal element.
   <16>

The image display device according to one or more of <1> to <15>,
further including a drive unit that moves the light guide plate in an eye relief direction that is a distance direction from the deflection part to the corneal vertex of the eyeball.
   <17>

The image display device according to one or more of <1> to <16>,
further including a calibration unit that acquires a deviation from a reference position of a user on the basis of a user operation on a calibration image including the image light.
   <18>

The image display device according to one or more of <1> to <17>,
further including a sensor unit that acquires an eye relief that is a distance from the deflection part to the corneal vertex of the eyeball, or a distance from the corneal vertex of the eyeball to the rotation center of the eyeball, or both.
   <19>

A light guide plate including:
a substrate that totally reflects and guides an incident image light;
a deflection part that condenses the image light at a rotation center of an eyeball; and
a detection unit that detects eyeball information that is information associated with an eyeball,
in which the deflection part condenses the image light switched on the basis of the eyeball information at the rotation center of the eyeball.
   <20>

The light guide plate according to <19>,
in which when the deflection part is formed on the eyeball side of the substrate, the following Expression (6) is satisfied, t>(L+r)*Φ/(2*r*tan φ) . . . (6)
where φ is an incident angle of the image light on the light guide plate,
L is an eye relief that is a distance from the deflection part to a corneal vertex of the eyeball,
r is a distance from the corneal vertex of the eyeball to the rotation center of the eyeball,
Φ is a pupil diameter of the eyeball, and
t is a thickness of the substrate.
   <21>

The light guide plate according to one or more of <19> to <20>,
in which when the deflection part is formed on a side opposite to the eyeball side of the substrate, the following Expression (15) is satisfied,

t>(L+r)*Φ/(2*r*(tan φ−tan θ1)) (15)
where φ is an incident angle of the image light on the light guide plate,
L is an eye relief that is a distance from the deflection part to the corneal vertex of the eyeball,
r is a distance from the corneal vertex of the eyeball to the rotation center of the eyeball,
Φ is a pupil diameter of the eyeball,
t is a thickness of the substrate, and
θ1 is an angle of view of the image light in the substrate.
   <22>

A system, comprising:
an eye tracking device that generates eyeball information of an eyeball of a user of the system;
an image output device that outputs light to the eyeball of the user; and
an image generator that generates and actively adjusts light traveling along an optical path to the image output device based on the eyeball information.
   <23>

The system of <22>, wherein the image output device outputs light to a predetermined area of the eyeball.

<24>

The system of one or more of <22> to <23>, wherein the light output to the predetermined area of the eyeball condenses at or near a rotation center of the eyeball.

<25>

The system of one or more of <22> to <24>, wherein the image output device comprises:
a light guide; and
an optical component that directs light traveling in the light guide to the eyeball of the user.
   <26>

The system of one or more of <22> to <25>, wherein the image generator comprises a movable mirror that actively adjusts a direction of the light traveling along the optical path to the image output device.

<27>

The system of one or more of <22> to <26>, further comprising:
a light shield that actively adjusts an amount of the light traveling along the optical path to the image output device.
   <28>

The system of one or more of <22> to <27>, further comprising:
a collimating lens positioned between the image generator and the image output device.
   <29>

The system of one or more of <22> to <28>, wherein the eyeball information includes line-of-sight information, pupil information, and eye relief information.

<30>

The system of one or more of <22> to <29>, wherein the pupil information comprises a diameter of a pupil of the eyeball.

<31>

The system of one or more of <22> to <30>, wherein the image output device is movable in a direction toward the eyeball of the user.

<32>

The system of one or more of <22> to <31>, further comprising:
a calibration device that determines the user's deviation from a reference position.
   <33>

The system of one or more of <22> to <32>, further comprising:
a sensor for sensing a distance between the image output device and a corneal vertex of the eyeball.
   <34>

The system of one or more of <22> to <33>, wherein the light generated by the image generator comprises laser light.

<35>

A system, comprising:
an image generator comprising:
a light source that generates light;
a controllable device that adjusts light output from the light source; and
a controller that controls the controllable device based on output of an eye tracking device that generates eyeball information of an eyeball of a user of the system, wherein the light output to the predetermined area of the eyeball condenses at or near a rotation center of the eyeball.
   <36>

The system of <35>, further comprising:
an image output device that outputs light received from the image generator to the eyeball of the user.
   <37>

The system of one or more of <35> to <36>, further comprising:
a collimating lens positioned between the image generator and the image output device.
   <38>

The system of one or more of <35> to <37>, wherein the controllable device comprises a controllable light shield positioned between the collimating lens and the image output device.

<39>

The system of one or more of <35> to <38>, wherein the controllable device comprises a movable mirror positioned between the light source and the collimating lens.

<40>

A method for a display system, comprising:
receiving eyeball information about an eyeball of a user of the display system;
generating light for displaying images to the eyeball of the user through an image output device; and
actively adjusting the light traveling along an optical path to the image output device based on the eyeball information such that light output from the image output device condenses at a center of rotation of the eyeball.
   <41>

The image generator of <40>, wherein actively adjusting the light includes controlling an optical element to redirect the light or to selectively block portions of the light.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 to 50 Image display device
100 image light generation unit
101 Light source
102 Light source drive unit
103 Deflection unit
104 Control unit
500 Light guide plate
500a Lens
500b Light shielding part
500d Incident part
500e Substrate
500f Deflection part
500g Drive unit
500h Calibration unit
500i Sensor unit
800 detection unit
1 Eyeball
2 Pupil
3 Lens
4 Retina
RC Rotation center

What is claimed is:

1. A system, comprising:
an eye tracking device that generates eyeball information of an eyeball of a user of the system;
an image output device that outputs light to the eyeball of the user; and
an image generator that generates and actively adjusts light traveling along an optical path to the image output device based on the eyeball information.

2. The system of claim 1, wherein the image output device outputs light to a predetermined area of the eyeball.

3. The system of claim 2, wherein the light output to the predetermined area of the eyeball condenses at or near a rotation center of the eyeball.

4. The system of claim 1, wherein the image output device comprises:
a light guide; and
an optical component that directs light traveling in the light guide to the eyeball of the user.

5. The system of claim 1, wherein the image generator comprises a movable mirror that actively adjusts a direction of the light traveling along the optical path to the image output device.

6. The system of claim 1, further comprising:
a light shield that actively adjusts an amount of the light traveling along the optical path to the image output device.

7. The system of claim 1, further comprising:
a collimating lens positioned between the image generator and the image output device.

8. The system of claim 1, wherein the eyeball information includes line-of-sight information, pupil information, and eye relief information.

9. The system of claim 8, wherein the pupil information comprises a diameter of a pupil of the eyeball.

10. The system of claim 1, wherein the image output device is movable in a direction toward the eyeball of the user.

11. The system of claim 1, further comprising:
a calibration device that determines the user's deviation from a reference position.

12. The system of claim 1, further comprising:
a sensor for sensing a distance between the image output device and a corneal vertex of the eyeball.

13. The system of claim 1, wherein the light generated by the image generator comprises laser light.

14. A system, comprising:
an image generator comprising:
a light source that generates light;
a controllable device that adjusts light output from the light source; and
a controller that controls the controllable device based on output of an eye tracking device that generates eyeball information of an eyeball of a user of the system, wherein the light output to the predetermined area of the eyeball condenses at or near a rotation center of the eyeball.

15. The system of claim 14, further comprising:
an image output device that outputs light received from the image generator to the eyeball of the user.

16. The system of claim 15, further comprising:
a collimating lens positioned between the image generator and the image output device.

17. The system of claim 16, wherein the controllable device comprises a controllable light shield positioned between the collimating lens and the image output device.

18. The system of claim 15, wherein the controllable device comprises a movable mirror positioned between the light source and the collimating lens.

19. A method for a display system, comprising:
receiving eyeball information about an eyeball of a user of the display system;
generating light for displaying images to the eyeball of the user through an image output device; and
actively adjusting the light traveling along an optical path to the image output device based on the eyeball information such that light output from the image output device condenses at a center of rotation of the eyeball.

20. The image generator of claim 19, wherein actively adjusting the light includes controlling an optical element to redirect the light or to selectively block portions of the light.
